(19) United States
(12) Patent Application Publication
(10) Pub. No.: US 2001/0021420 A1
(43) Pub. Date: Sep. 13, 2001

(54) Method and apparatus for transferring ink, varnish or adhesive during laminating and printing, particularly flexographic printing

(75) Inventors: Manfred Hornschuh, Hilter (DE); Eugen Herzau, Baalsdorf (DE); Leopold Sudao, Hasbergen-Gaste (DE)

Correspondence Address: Friedrich Kueffner, Suite 1921, 342 Madison Avenue, New York, NY, 10173, US

(73) Assignee: Manfred Honschuh and Windmoller & Holscher KG

(21) Appl. No.: 09/738,864

(22) Filed: Dec. 15, 2000

(30) Foreign Application Priority Data
Dec. 17, 1999 (DE) 199 61 369.9

(51) Int. Cl. B05D 1/28; B05C 1/00; B05D 3/12; B05D 1/02

(52) U.S. Cl. 427/428; 427/421; 427/356; 118/244

(57) ABSTRACT

A method and an apparatus for transferring ink, varnish or adhesive during laminating or printing, particularly flexographic printing, operates with a roller in the form of a smooth roller for transferring the material from the smooth roller to a substrate. A plurality of spray modules arranged next to each other and individually controllable is provided for spraying the material onto one or more cylindrical portions of the smooth roller. A doctor blade is arranged following the point of transfer of the material as seen in the direction of rotation of the smooth roller.

### BACKGROUND OF THE INVENTION

1. Field of the Invention

The invention relates to a method and an apparatus for transferring ink, varnish or adhesive during laminating or printing, particularly flexographic printing, with the use of a roller.

2. Description of the Related Art

The method and the apparatus according to the present invention can essentially be used for transferring different materials which are processed in a manner similar to that of printing inks. Among these are not only various varnishes and inks, but also adhesives which are used, for example, during laminating, i.e. for connecting foils over large surfaces thereof. In the following, the invention will be described essentially in connection with the transfer of ink, i.e., in connection with printing, although other fields of use are conceivable. Thus, the term ink shall also include similar materials, such as varnishes and adhesives.

During flexographic printing generally and offset printing specifically (when a “short” inker unit is used), the ink quantity is metered through a so-called screen roller.

Such a screen roller is a cylinder on whose surface are mounted small cups in a predetermined order, wherein the small cups are either forged in copper or lasered into a ceramic layer applied to the cylinder. In the printing machine, the roller travels through an ink bath. In this process, the cups are filled in an uncontrolled manner and are certainly never completely filled with ink. The quantity of air entrained in the direction of rotation of the cylinder increases with increasing speed of the machine. The resulting turbulences at the roller surface prevents the small cups from being filled with ink.

In flexographic printing, the ink adhering to the surfaces of the webs are scraped from the roller surface with a doctor blade. The webs which, on the one hand, separate the small cups on the roller from each other and, on the other hand, serve as a support surface for the doctor blade, become visible as the ink film is being built up and the ink layer itself is “perforated” by the webs. In accordance with the present state of the art of flexographic printing, this porosity of the ink film can be compensated only by an exorbitant increase of the ink transfer quantity. Because the ink film is proportionally too thick, the web contours blur optically, and simultaneously the printing quality in motif printing is reduced by an increase of the ink which is too high. This excessive use of ink and solvent requires drying with a higher energy use.

At the present time, it is not possible in flexographic printing to partially control the ink application over the work width or to change the thickness of the ink film. In accordance with the present state of the art, any required change of the ink quantity can only be achieved by replacing the screen roller by another screen roller with a different cup geometry. Since only in the rarest cases will a roller with the required cup geometry be available, compromises and the attendant decreases of quality are the result. The tolerances when shaping the cups during the manufacturing process of the roller are relatively high. Consequently, the ink film which is picked up varies over the work width as well as in the rolling direction.

In order to be able to print an image, it must preferably be converted into an analog screen or a frequency modulated dot structure. In the analog screen, the distance from center point to center point of a block screen is always the same. Lighter areas have a very small dot, while darker areas have a large dot. The so-called light dot of a screen with, for example, 48 lines per centimeter preferably has a dot size of 2% area coverage. Area coverage is understood to be the percentage of a covered area in relation to the full area. The dot with a 2% area coverage in the 48 line block screen has a diameter of about 0.033 mm. To prevent the block screen dot from entering into the cup of the screen roller, the dot must always be greater than the cup, or the cup must be smaller than the screen dot.

This results in extremely complicated relationships. Fine screen rollers are substantially more expensive as compared to coarse screen rollers and have a substantially shorter service life and are not suitable for printing large areas because of the low ink pickup. In contrast, coarse block screens suitable for coarse lined screen rollers with longer service life produce optically a “torn apart” image with extremely limited reproduction of details. Larger light dots in fine block screens, in turn, not only extremely limit the space for ink mixing, they also pick up more ink and, thus, transfer lighter areas in a smudged manner. When the screen roller is used as an ink metering instrument, the printing technology in flexographic printing becomes more complicated and extremely reduces the printing quality as compared to other printing methods.

In accordance with the present state of the art, when the screen roller is wetted it picks up ink over the entire width thereof, even if printing is only carried out partially over a narrow strip. Since NC-flexographic ink consists of almost two thirds solvent in order to be able to “transport” the ink during the transfer, a large portion of the non-utilized ink on the roller evaporates. These permanently evaporating solvents contaminate the environment and must be permanently replaced. The ink layer which is relatively thick and applied over a large surface area must be dried on the printing substrate with high quantities of energy in such a way that almost no residual solvent remains which could impair the printed product.

In accordance with the present state of the art of flexographic printing, inks which can be diluted with water must be diluted with relatively high quantities of water for the transfer from the ink basin over the screen roller and block onto the printing substrate. In proportion to the introduced quantity of water, a high energy quantity is required after the transfer onto the printing substrate for drying the cross-linking ink to such an extent that it adheres and can also be printed over once again.

Since the portion of solids in solvent inks in flexographic printing only is about one third and the solvent portion to be evaporated is about two thirds, the ink film changes permanently during the duration of the entire printing process. Variations within the mixture of solvent and solids result in changes of the colors of the printed image and impair the capability of expression.

### SUMMARY OF THE INVENTION

Therefore, it is the primary object of the present invention to provide a method and an apparatus of the above-described type which make it possible to carry out the above-described laminating or printing methods more economically and reliably with better quality, and in which the quantity of material used and the contamination of the environment are decreased.

In accordance with the present invention, the material to be transferred is sprayed onto a smooth roller.

Accordingly, the present invention basically utilizes a relatively smooth roller which no longer has the disadvantages of a screen roller. The material to be transferred is sprayed onto the smooth roller which produces significant advantages.

The material film, i.e., ink film, which is applied in this manner and is continuous is not transferred once over a large surface area, as is the case when inking takes place through a screen roller, but rather the material film is built up from a controlled quantity of droplets within the ink layer and over the surface area thereof. The droplets burst when they impinge upon the smooth roller and form on the ink roller a homogenous and reproducible ink film; this is in contrast to the porous ink film of the screen roller inking using the webs of cups. Depending on the quantity of air and viscosity of the ink, the number of droplets per roller rotation as well as the speed thereof can be controlled.

While in the case of a screen roller the ink film is transferred relatively thick in a single layer, and over a surface area, in accordance with the present invention the material layer is built up from a plurality of droplets. Because of the disproportionately high surface area of all droplets of which the ink layer is built up, drying takes place already in the air flow. This reduces the energy required for drying by about 90% as compared to a film which is built up over a surface area on a screen roller.

Since the ink transfer takes place through a smooth roller, there are no tolerances in the ink layer as a consequence of the cup tolerances as used in screen roller inking.

In accordance with the present invention, the material quantity which has not been picked up, is relatively thin, closed and almost dried, is removed by a doctor only after the transfer. This also eliminates the ink transfer problems caused by the doctor system used in screen roller inking in which the quality of the low viscosity ink film depends substantially on the location and pressure of the doctor.

The material properties, roughness and surface energy of the smooth roller are selected in accordance with the ink system to be used. The smooth roller then acts as a positioning and ink separating medium. By using spray technology, the ink film can be kept extremely thin and can be applied completely continuously. The modular arrangement of the spray heads permits a partial inking of the roller over the work width only where ink is required for inking the block. This makes it possible to save approximately 75% of the solvent.

In particular, it is possible in accordance with the invention to ink the smooth roller by spraying in a modular manner and, thus, in a controllable manner over the work width and with respect to the color intensity.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a schematic side view of an apparatus according to the present invention; and

FIG. 2 is a schematic cross-sectional view of the apparatus of FIG. 1.

### DESCRIPTION OF THE PREFERRED EMBODIMENTS

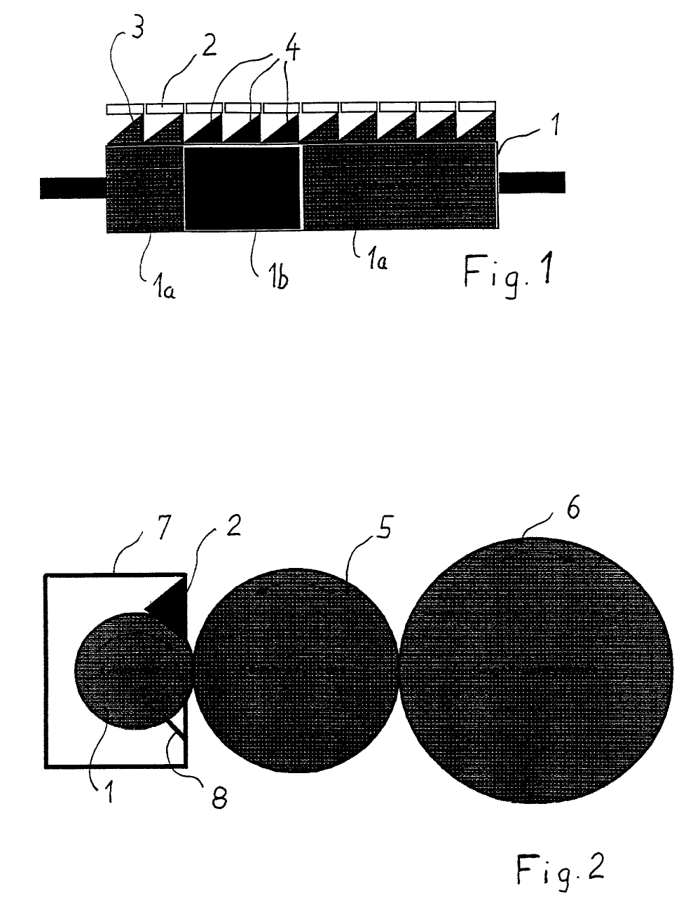

The apparatus illustrated in the drawing includes a smooth roller 1 and a plurality of spray modules 2 arranged above the smooth roller 1. The spray modules can be controlled individually so that controllable quantities and intensities of ink can be sprayed onto the smooth roller. As seen in FIG. 1, a cylindrical portion of the roller is denoted by 1b, wherein the intensity of the spray jets 4 sprayed onto the portion 1b is different from that of the spray jets 3 sprayed onto the cylindrical portion 1a.

As illustrated in FIG. 2, the smooth roller 1 is sprayed with ink by means of the spray modules 2. The smooth roller transfers the sprayed ink onto a printing cylinder, in this case a block cylinder 5 which cooperates with a counter pressure cylinder 6.

A doctor blade 8 is arranged together with the smooth roller 1 and the spray module 2 in a housing 7. The doctor blade 8 is arranged following the block cylinder 5 in the direction of rotation of the smooth roller 1, i.e., the excess ink is removed only after printing.

The apparatus according to the present invention has hereinabove been described in connection with transferring ink during printing. However, the present invention also makes it possible to transfer layers of other materials, such as varnishes or adhesives. For transferring adhesives for connecting foils, i.e., for laminating, screen rollers have also been used in the past, wherein the screen rollers have the disadvantages described above. These screen rollers are now replaced by relatively smooth rollers, so that the advantages described above are obtained. Varnishes or adhesives can be transferred directly from the smooth roller onto the substrate without the intermediate arrangement of a printing unit.

While specific embodiments of the invention have been shown and described in detail to illustrate the inventive principles, it will be understood that the invention may be embodied otherwise without departing from such principles. +

What is claimed is:

1. A method of transferring a material selected from ink, varnish or adhesive during laminating or printing, particularly flexographic printing, the method comprising spraying the material onto a smooth roller and transferring the material from a smooth roller onto a substrate.

2. The method according to claim 1, comprising removing excess material after the material transfer from the smooth roller using a doctor blade.

3. The method according to claim 1, comprising controlling a quantity of the material independently of a speed of operation of the roller.

4. The method according to claim 1, comprising utilizing a modular spray technology for spraying the material onto one or more cylindrical portions of the smooth roller.

5. The method according to claim 4, comprising variably controlling a color intensity of individual cylindrical portions when spraying ink onto the smooth roller.

6. An apparatus for transferring a material selected from ink, varnish or adhesive during laminating or printing, particularly flexographic printing, the apparatus comprising a smooth roller for transferring the material onto a substrate and a plurality of spray modules mounted next to each other in an axial direction of the smooth roller for spraying the material onto the smooth roller.

7. The apparatus according to claim 6, wherein the spray modules are individually controllable with respect to quantity as well as intensity.

8. The apparatus according to claim 6, further comprising a doctor blade mounted following a point of material transfer in a direction of rotation of the smooth roller.
